(19) United States
(12) Patent Application Publication
(10) Pub. No.: US 2026/0171295 A1
(43) Pub. Date: Jun. 18, 2026

(54) COIL COMPONENT

(71) Applicant: SAMSUNG ELECTRO-MECHANICS CO., LTD., Suwon-si (KR)

(72) Inventors: Dong Jin LEE, Suwon-si (KR); Dong Hwan LEE, Suwon-si (KR); Tae Hyun KIM, Suwon-si (KR); Soon Kwang KWON, Suwon-si (KR); Jin Hyuck YANG, Suwon-si (KR)

(73) Assignee: SAMSUNG ELECTRO-MECHANICS CO., LTD., Suwon-si (KR)

(21) Appl. No.: 19/314,239

(22) Filed: Aug. 29, 2025

(30) Foreign Application Priority Data
Dec. 17, 2024 (KR) 10-2024-0188475

(51) Int. Cl. H01F 27/28; H01F 27/06

(52) U.S. Cl. CPC H01F 27/28; H01F 27/06

(57) ABSTRACT

A coil component includes a body having a first surface and a second surface, opposing each other in a first direction, a third surface and a fourth surface opposing each other in a second direction, and a fifth surface and a sixth surface opposing each other in a third direction, the body including a magnetic material, a coil including a winding portion disposed in the body and a lead wire extending to the first surface and the second surface of the body, and a lead frame including an anchor portion at least partially disposed in the body, the lead frame disposed on the first surface and the second surface of the body and connected to the lead wire. The anchor portion may include at least one blade protruding in the third direction while being twisted about the third direction as an axis.

### CROSS-REFERENCE TO RELATED APPLICATION(S)

This application claims benefit of priority to Korean Patent Application No. 10-2024-0188475 filed on Dec. 17, 2024 in the Korean Intellectual Property Office, the disclosure of which is incorporated herein by reference in its entirety.

### TECHNICAL FIELD

The present disclosure relates to a coil component.

An inductor, a coil component, may be a representative passive electronic component used in electronic devices, along with a resistor and a capacitor.

Recently, the market for high-current power inductors used in AI, automotive electronics, and robotics has been increasing. In particular, the importance of an inductor device efficiency has emerged against the backdrop of an increase in current and voltage used by electronic devices.

Medium and large-sized power inductors consist mainly of a magnetic material, a coil, and a lead frame. When a magnetic material body is molded, high pressure may cause displacement or misalignment of the coil and lead frame, resulting in degradation in inductor properties and defects.

### SUMMARY

An aspect of the present disclosure is to provide a coil component capable of preventing defects caused by displacement and misalignment of a coil.

According to an aspect of the present disclosure, there is provided a coil component including a body having a first surface and a second surface, opposing each other in a first direction, a third surface and a fourth surface opposing each other in a second direction, and a fifth surface and a sixth surface opposing each other in a third direction, the body including a magnetic material, a coil including a winding portion disposed in the body and a lead wire extending to the first surface and the second surface of the body, and a lead frame including an anchor portion at least partially disposed in the body, the lead frame disposed on the first surface and the second surface of the body and connected to the lead wire. The anchor portion may include at least one blade protruding in the third direction while being twisted about the third direction as an axis.

According to another aspect of the present disclosure, there is provided a coil component including body having a first surface and a second surface, opposing each other in a first direction, a third surface and a fourth surface opposing each other in a second direction, and a fifth surface and a sixth surface opposing each other in a third direction, the body including a magnetic material, a coil including a winding portion disposed in the body and a lead wire extending to the first surface and the second surface of the body, and a lead frame including an anchor portion at least partially disposed in the body, the lead frame disposed on the first surface and the second surface of the body and connected to the lead wire. The anchor portion may have a first surface and a second surface opposing the first surface in the third direction. The first surface and the second surface of the anchor portion may include a first blade and a third blade, respectively, the first blade and the second blade protruding in the third direction.

According to example embodiments of the present disclosure, a coil component may prevent defects caused by displacement and misalignment of a coil.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a coil component according to an example embodiment of the present disclosure;

FIG. 2 is a side view of the coil component according to the example embodiment illustrated in FIG. 1;

FIG. 3 is a top view of the coil component according to the example embodiment illustrated in FIG. 1;

FIG. 4 is an exploded view of a coil component according to an example embodiment of the present disclosure;

FIG. 5 is a view of a first lead frame according to an example embodiment of the present disclosure;

FIG. 6 is a perspective view of a coil component according to a modification of the present disclosure; and

FIG. 7 is a view of a first lead frame according to a modification of the present disclosure.

### DETAILED DESCRIPTION

The terms used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this code, specify the presence of stated features, integers, steps, operations, elements, components or a combination thereof, but do not preclude the presence or addition of one or more other features, integers, steps, operations, elements, components, and/or groups thereof. In addition, the terms “disposed on,” “positioned on,” and the like, may mean that an element is positioned on or below a target portion, and may not necessarily mean that the element is positioned on an upper side of the target portion with respect to a direction of gravity.

The terms “coupled to,” “connected to,” and the like, may not only indicate that elements are directly and physically in contact with each other, but also include a configuration in which another element is interposed between the elements such that the elements are also in contact with the other element.

The size and thickness of each element illustrated in the drawings is arbitrarily represented for ease of the description, but the present disclosure is not limited to those illustrated herein.

In the drawings, an X-direction may be defined as a first direction or a length direction, a Y-direction may be defined as a second direction or a width direction, and a Z-direction may be defined as a third direction or a thickness direction.

Hereinafter, a coil component according to an example embodiment of the present disclosure will be described in detail with reference to the accompanying drawings. In the description with reference to the accompanying drawings, the same or corresponding elements are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high frequency (HF) inductor, a general bead, a high-frequency bead (GHz bead), a common mode filter, or the like.

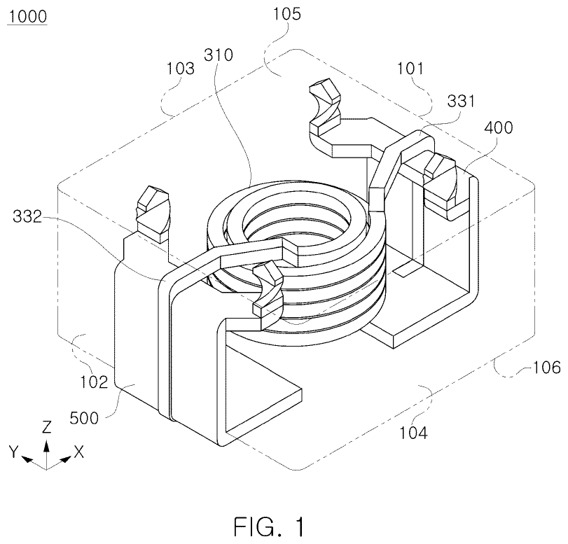

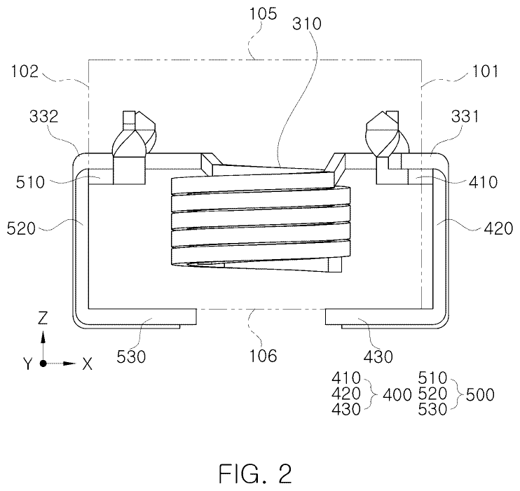

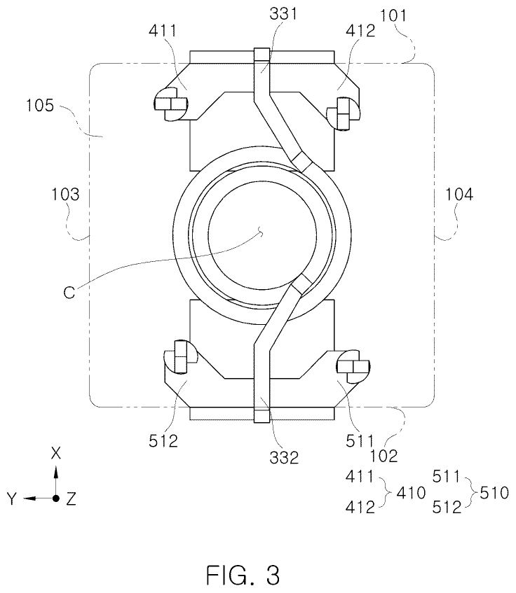

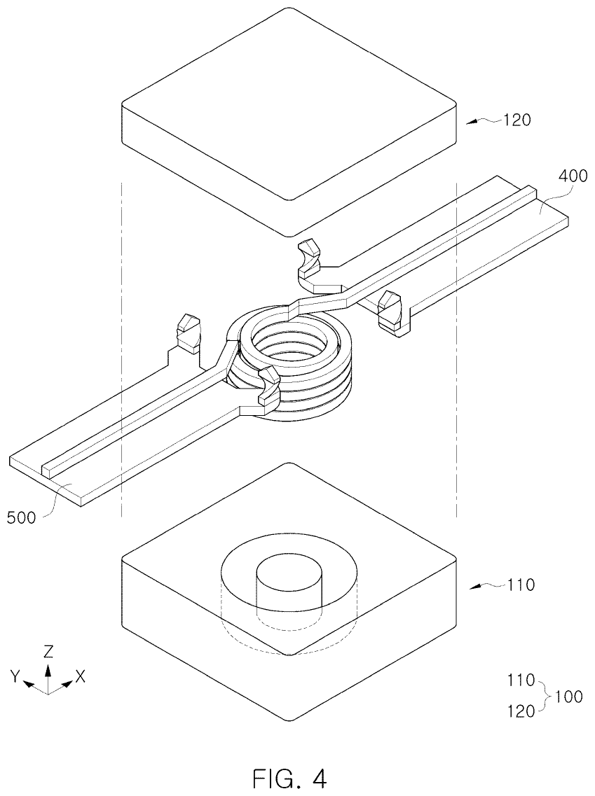

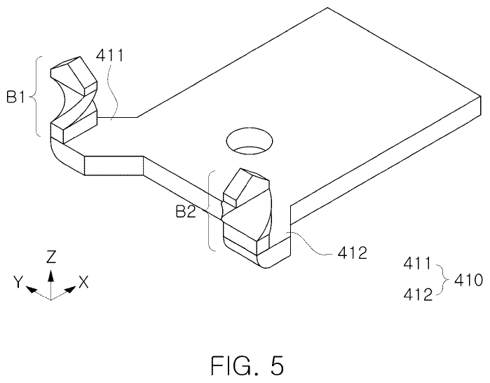

FIG. 1 is a perspective view of a coil component according to an example embodiment of the present disclosure. FIG. 2 is a side view of the coil component according to the example embodiment illustrated in FIG. 1. FIG. 3 is a top view of the coil component according to the example embodiment illustrated in FIG. 1. FIG. 4 is an exploded view of a coil component according to an example embodiment of the present disclosure. FIG. 5 is a view of a first lead frame according to an example embodiment of the present disclosure.

Referring to FIG. 1, a coil electronic component according to an example embodiment of the present disclosure may include a body 100 including a magnetic material, a coil 300 disposed in the body 100, and lead frames 400 and 500 disposed on a first surface and a second surface of the body.

The body 100 may form the overall exterior of a coil component 1000 according to the present example embodiment, and may include the coil 300 buried therein.

The body 100 may have an overall hexahedral shape. Referring to FIG. 1, the body 100 may include a first surface 101 and a second surface 102 opposing each other in a first direction (X-direction), a third surface 103 and a fourth surface 104 opposing each other in a second direction (Y-direction), and a fifth surface 105 and a sixth surface 106 opposing each other in a third direction (Z-direction). The first surface 101, the second surface 102, the third surface 103, and the fourth surface 104 of the body 100 may correspond to a plurality of side surfaces of the body 100 connecting the fifth surface 105 and the sixth surface 106 to each other.

The body 100 may be formed such that the coil component 1000 according to the present example embodiment, in which the lead frames 400 and 500 to be described below are formed, may have a length of 4.0 mm and a width of 4.0 mm, a length of 5.0 mm and a width of 5.0 mm, a length of 6.0 mm and a width of 6.0 mm, or a length 13.0 mm and a width of 13.0 mm, but the present disclosure is not limited thereto. The above-described sizes of the coil component 1000 are merely exemplary, and a case in which the coil component 1000 has a size other than the above-described sizes is not excluded from the scope of the present disclosure.

The body 100 may include a magnetic material. The body 100 may be formed by filling a mold with a magnetic material, and may be formed by filling the mold with a composite material including a magnetic material and an insulating resin. A molding process of applying high temperature and high pressure to the magnetic material or the composite material in a mold may be additionally performed, but the present disclosure is not limited thereto.

The magnetic material included in the body 100 may be, for example, ferrite or metal magnetic powder.

The ferrite may be, for example, at least one of spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, or the like, hexagonal ferrite such as Ba—Zn-based ferrite, Ba—Mg-based ferrite, Ba—Ni—based ferrite, Ba—Co-based ferrite, Ba—Ni—Co-based ferrite, or the like, garnet-type ferrite such as Y-based ferrite or the like, or Li-based ferrite.

The magnetic metal powder may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder may be at least one of pure iron powder, Fe—Si-based alloy powder, Fe—Si-Al-based alloy powder, Fe—Ni—based alloy powder, Fe—Ni—Mo-based alloy powder, Fe—Ni—Mo-Cu-based alloy powder, Fe—Co-based alloy powder, Fe—Ni—Co-based alloy powder, Fe—Cr-based alloy powder, Fe—Cr—Si-based alloy powder, Fe—Si—Cu—Nb-based alloy powder, Fe—Ni—Cr-based alloy powder, or Fe—Cr—Al-based alloy powder.

The magnetic metal powder may be amorphous or crystalline. For example, the magnetic metal powder may be Fe—Si—B—Cr-based amorphous alloy powder, but the present disclosure is not necessarily limited thereto.

In the body 100, the ferrite and metal magnetic powder may be existed in a form of magnetic particle, and the ferrite particle and metal magnetic particle may respectively have an average diameter of about 0.1 μm to 30 μm, but an embodiment thereof is not limited thereto.

The body 100 may include two or more types of magnetic materials dispersed in the resin. Here, different types of magnetic materials mean that the magnetic materials are distinguished from each other in terms of one of an average diameter, a composition, crystallinity, and a shape. For example, the body 100 may include two or more types of magnetic particles having different particle diameters.

The insulating resin may include epoxy, polyimide, a liquid crystal polymer, or the like alone or in combination, but the present disclosure is not limited thereto.

The body 100 may include a molded portion 110 in which a coil is disposed, and a cover portion 120 disposed on the molded portion 110.

The molded portion 110 may be disposed on a lower portion of the cover portion 120, and may include the coil 300 disposed therein. The molded portion 110 may have one surface (upper surface) opposing the cover portion 120, the other surface (lower surface) opposing the one surface, and a plurality of side surfaces connecting the one surface and the other surface to each other. The plurality of side surfaces of the molded portion 110 may be included in a portion of the plurality of side surfaces of the body 100.

The molded portion 110 may include a core C passing through the coil 300. Here, “passing through the coil 300” may refer to passing through an air core of the coil 300 forming at least one turn. The core C may be disposed in an internal region of the coil 300 forming at least one turn, and may have a circular or elliptical cross-section.

The cover portion 120 may be disposed on an upper surface (one surface) of the molded portion 110 to cover the coil 300. After being disposed on the molded portion 110 and the coil 300, the cover portion 120 may be press-fitted to be coupled to the molded portion 110. The cover portion 120 may have one surface (lower surface) opposing the molded portion 110, the other surface (upper surface) opposing the one surface, and a plurality of side surfaces connecting the one surface and the other surface to each other. The plurality of side surfaces of the cover portion 120 may be included in the plurality of side surfaces of the body 100, together with the side surfaces of the molded portion 110.

The coil 300 may be disposed in the body 100 to exhibit properties of the coil component 1000. For example, when the coil component 1000 according to the present example embodiment is used as a power inductor, the coil 300 may serve to stabilize power of an electronic device by storing an electric field as a magnetic field and maintaining an output voltage.

The coil 300 may include a winding portion 310 forming at least one turn around the core C, and lead wires 331 and 332 connected to the lead frame to be described below.

Referring to FIGS. 1 to 3, the winding portion 310 may form a plurality of turns toward the outside of the body 100 in the first direction (X-direction) and the second direction (Y-direction) from the core C. The winding portion 310 may be disposed to be parallel to the sixth surface 106 of the body, and a winding axis of the winding portion 310 may be formed to be parallel to the third direction (Z-direction).

The winding portion 310 may be wound in an overall circular or elliptical shape, and the core C may be disposed at the center of the winding portion 310.

First and second lead wires 331 and 332 may be connected to both ends of the winding portion 310, and may be connected to first and second lead frames 400 and 500, respectively.

The coil 300 may be an air core coil, and may include a metal wire MW having a circular cross-section, or may be configured as a rectangular coil, but the present disclosure is not limited thereto.

The coil 300 may be formed by winding a conductive metal, and a portion of the coil 300 that is not in contact with the lead frames 400 and 500 to be described below may be coated with an insulating film. Specifically, the coil 300 may be formed by spirally winding a metal wire (MW), such as copper wire (Cu-wire) including a metal line and an insulating film coating a surface of the metal line.

Referring to FIGS. 1 to 3, the lead frames 400 and 500 may be disposed on the first surface 101 and the second surface 102 of the body 100, and may serve as external electrodes of the coil component according to the present example embodiment.

The lead frames 400 and 500 may include a first lead frame 400 disposed on the first surface 101 and the sixth surface 106 of the body 100, and a second lead frame 500 disposed on the second surface 102 and the sixth surface 106 of the body 100. The first lead frame 400 may be connected to a first lead wire 331, and the second lead frame 500 may be connected to a second lead wire 332.

The first lead frame 400 may include an anchor portion 410 at least partially disposed in the body 100, a connection portion 420 disposed on the first surface 101 of the body 100, and an extension portion 430 disposed on the sixth surface 106 of the body 100.

The anchor portion 410 may be disposed in the body 100 and may serve to improve adhesive strength between the first lead frame 400 and the body 100. The anchor portion 410 may have one surface (e.g., first surface) opposing the fifth surface 105 of the body 100 and the other surface (e.g., second surface) opposing the sixth surface 106 of the body 100. Referring to FIG. 1, the one surface of the anchor portion 410 may refer to an upper surface, and the other surface may refer to a lower surface.

The anchor portion 410 may include one end (e.g., first end) 411 and the other end (e.g., second end) 412 spaced apart from each other in the second direction (Y-direction). The one end 411 and the other end 412 may be spaced apart from each other in the second direction (Y-direction), such that the anchor portion 410 may have a Y-shape. The coil 300 may be bonded between the one end and the other end of the anchor portion. The anchor portion 410 may extend to the first surface 101 of the body 100, together with the coil 300, and may be connected to the connection portion 420 to be described below.

Referring to FIG. 5, the anchor portion 410 may include at least one blade B protruding in the third direction (Z-direction) while being twisted about the third direction as an axis.

FIG. 4 is an exploded view of a coil component according to an example embodiment of the present disclosure. In a state in which the coil and the lead frame are welded to each other, when the molded portion 110 and the cover portion 120 are inserted and pressurization for main molding is performed, the body may undergo a main molding process in which the body is remolded under high molding pressure. In this case, due to the high molding pressure, displacement and misalignment of the coil and the lead frame may occur, which may cause degradation in inductor properties and defects. The blade B of the lead frame may function as a support during pressurization for molding the body, such that the lead frame of the coil component according to the present example embodiment may prevent displacement and misalignment of the coil and the lead frame.

The blade B may be a helical protrusion provided on the anchor portion 410. The blade B may be formed by bending a portion of an end of the anchor portion 410 in the third direction (Z-direction). The blade B may be twisted in a clockwise direction (or counterclockwise direction) about the third direction as an axis when being bent. As described above, a surface area of the blade may be increased in a helical shape, thereby improving support strength of the lead frame. An end of the blade B may have a triangular structure, and thus the blade B may maintain a helical structure thereof without being compressed by magnetic powder particles during a high-pressure pressurization process.

The blade B may be provided at each of the one end 411 and the other end 412 of the anchor portion. The blade B may be provided at an end of the anchor portion, and may not be in contact with the coil 300. When viewed in the third direction, the blade B may not overlap the coil 300. The one end 411 of the anchor portion may include a first blade B1, and the other end 412 may include a second blade B2. The first blade B1 and the second blade B2 may be formed in different directions on different edges of the respective ends. Referring to FIG. 5, the first blade B1 may be formed on a side portion of the one end 411, and the second blade B2 may be formed on a front portion of the other end 412. Accordingly, the first blade B1 may be formed so as not to oppose the second blade B2 in the second direction (Y-direction). The first blade B1 and the second blade B2 may be bent in different directions, thereby improving support strength of the lead frame.

The blade B may be provided on one surface (upper surface) of the anchor portion 410. The blade B provided on the upper surface of the anchor portion 410 may be referred to as an upper blade (e.g., first blade).

Referring to FIG. 4, the blade B according to the present example embodiment may be in contact with the cover portion 120 of the body 100. The blade B may be bent in a direction in which pressure is applied by a mold or the like during molding of the body 100, and may be in contact with the cover portion 120.

The connection portion 420 may be disposed on the first surface 101 of the body 100. The extension portion 430 may be disposed on the sixth surface 106 of the body 100. The first lead frame 400 may be led out to a side surface of the body through the connection portion 420 and the extension portion 430, and may be bent toward a lower surface of the body. The first lead wire 331 may be disposed on external surfaces of the connection portion 420 and the extension portion 430, and thus may extend to a lower surface of the coil component.

The second lead frame 500 may include an anchor portion 510 at least partially disposed in the body 100, a connection portion 520 disposed on the second surface 102 of the body 100, and an extension portion 530 disposed on the sixth surface 106 of the body 100.

The anchor portion 510 may be disposed in the body 100 and may serve to improve adhesive strength between the lead frame 500 and the body 100. The anchor portion 510 may have one surface opposing the fifth surface 105 of the body 100, and the other surface opposing the sixth surface 106 of the body 100. Referring to FIG. 1, the one surface of the anchor portion 510 may be referred to as an upper surface, and the other surface may be referred to as a lower surface.

The anchor portion 510 may include one end 511 and the other end 512 spaced apart from each other in the second direction (Y-direction). The one end 511 and the other end 512 may be spaced apart from each other in the second direction (Y-direction), such that the anchor portion 510 may have a Y-shape. The coil 300 may be bonded between the one end and the other end of the anchor portion. The anchor portion 510 may extend to the second surface 102 of the body 100, together with the coil 300, and may be connected to the connection portion 520 to be described below.

Referring to FIG. 4, the anchor portion 410 may include at least one blade B protruding in the third direction (Z-direction) while being twisted about the third direction as an axis.

The description of the blade B may overlap the above description of the first lead frame 400, and thus a detailed description will be omitted.

The connection portion 520 may be disposed on the second surface 102 of the body 100. The extension portion 530 may be disposed on the sixth surface 106 of the body 100. The second lead frame 500 may be led out to a side surface of the body through the connection portion 520 and the extension portion 530, and may be bent toward a lower surface of the body. The extension portion 530 of the second lead frame may be disposed on the sixth surface 106 of the body to be spaced apart from the extension portion 430 of the first lead frame. The second lead wire 332 may be disposed on external surfaces of the connection portion 520 and the extension portion 530, and thus may extend to a lower surface of the coil component.

The lead frames 400 and 500 may include a metal such as copper (Cu), silver (Ag), palladium (Pd), nickel (Ni), or the like. The metal is not limited as long as the metal is a conductive metal. Although not illustrated in the drawings, a metal layer may be formed on internal surfaces and external surfaces of the lead frames 400 and 500. The metal layer may serve to bond the lead wires 331 and 332 and the lead frames 400 and 500 to each other, and may be formed using a process such as dipping or soldering. Metal layers 440 and 540 may include nickel (Ni), tin (Sn), copper (Cu), or the like, and may have a multilayer structure.

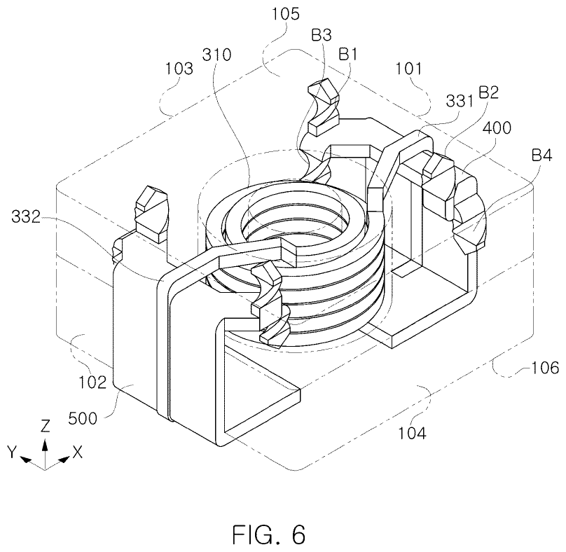

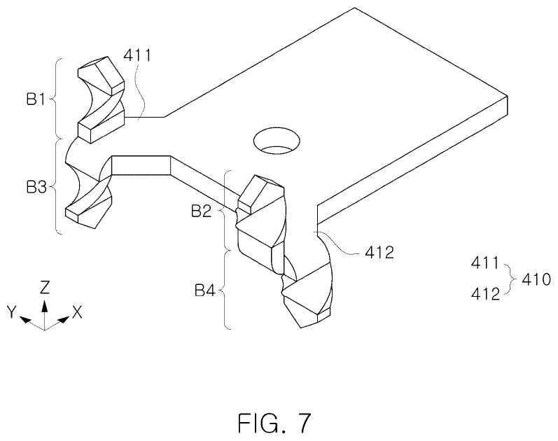

FIG. 6 is a perspective view of a coil component according to a modification of the present disclosure. FIG. 7 is a view of a first lead frame according to a modification of the present disclosure.

Referring to FIGS. 6 and 7, lower blades (e.g., third and fourth blades) B3 and B4 may be provided on the other surface (lower surface) of an anchor portion 410. The lower blades B3 and B4 may be formed toward a lower surface of a body 100, that is, in a direction symmetrical to a direction in which pressure is applied by a mold or the like during molding of the body 100. The lower blades B3 and B4 may be in contact with a molded portion 110, thereby improving support strength of a lead frame 400.

In addition, the lower blades B3 and B4 may be twisted in a counterclockwise direction about a third direction Z-direction as an axis. The lower blades B3 and B4 may be twisted in a direction opposite to that of upper blades (e.g., first and second blades) B1 and B2, thereby further improving support strength of the lead frame 400.

While example embodiments have been shown and described above, it will be apparent to those skilled in the art that modifications and variations could be made without departing from the scope of the present disclosure as defined by the appended claims.

What is claimed is:

1. A coil component comprising:
a body having a first surface and a second surface, opposing each other in a first direction, a third surface and a fourth surface opposing each other in a second direction, and a fifth surface and a sixth surface opposing each other in a third direction, the body including a magnetic material;
a coil including a winding portion disposed in the body and a lead wire extending to the first surface and the second surface of the body; and
a lead frame including an anchor portion at least partially disposed in the body, the lead frame disposed on the first surface and the second surface of the body and connected to the lead wire,
wherein the anchor portion includes at least one blade protruding in the third direction while being twisted about the third direction as an axis.

2. The coil component of claim 1, wherein
the at least one blade includes a first blade and a second blade,
the anchor portion includes a first end and a second end spaced apart from each other in the second direction, and
the first end includes the first blade, and the second end includes the second blade.

3. The coil component of claim 2, wherein the first blade and the second blade do not oppose each other in the second direction.

4. The coil component of claim 1, wherein
the at least one blade includes a first blade and a third blade,
the anchor portion has a first surface and a second surface opposing the first surface in the third direction, and
the first surface of the anchor portion includes the first blade, and the second surface of the anchor portion includes the third blade.

5. The coil component of claim 4, wherein
the first blade protrudes toward the fifth surface of the body, and
the third blade protrudes toward the sixth surface of the body.

6. The coil component of claim 4, wherein
the first blade is twisted in a counterclockwise direction about the third direction as an axis, and
the third blade is twisted in a clockwise direction about the third direction as an axis.

7. The coil component of claim 1, wherein, when viewed in the third direction, the at least one blade does not overlap the coil.

8. The coil component of claim 1, wherein the body includes a molded portion, and a cover portion covering the molded portion, and
the coil is disposed in the molded portion.

9. The coil component of claim 8, wherein the at least one blade is in contact with the cover portion.

10. The coil component of claim 1, wherein the lead frame further includes a connection portion disposed on the first surface and the second surface of the body, and an extension portion disposed on the sixth surface of the body.

11. The coil component of claim 2, wherein the first blade has a first end portion on the first end of the anchor portion, the second blade has a second end portion on the second end of the anchor portion, and a first longitudinal axis of the first end portion and a second longitudinal axis of the second end portion are disposed at an angle relative to each other.

12. The coil component of claim 11, wherein the first blade is twisted in a quarter turn counterclockwise about the third direction as an axis, and
the second blade is twisted in a quarter turn clockwise about the third direction as an axis.

13. The coil component of claim 6, wherein
the first blade is twisted in a quarter turn counterclockwise about the third direction as an axis, and
the third blade is twisted in a quarter turn clockwise about the third direction as an axis.

14. A coil component comprising:
a body having a first surface and a second surface, opposing each other in a first direction, a third surface and a fourth surface opposing each other in a second direction, and a fifth surface and a sixth surface opposing each other in a third direction, the body including a magnetic material;
a coil including a winding portion disposed in the body and a lead wire extending to the first surface and the second surface of the body; and
a lead frame including an anchor portion at least partially disposed in the body, the lead frame disposed on the first surface and the second surface of the body and connected to the lead wire,
wherein the anchor portion has a first surface and a second surface opposing the first surface in the third direction, and
the first surface and the second surface of the anchor portion include a first blade and a third blade, respectively, the first blade and the third blade protruding in the third direction.

15. The coil component of claim 14, wherein
the first blade protrudes toward the fifth surface of the body, and
the third blade protrudes toward the sixth surface of the body.

16. The coil component of claim 14, wherein
the first blade protrudes in the third direction while being twisted in a counterclockwise direction about the third direction as an axis, and
the third blade protrudes in the third direction while being twisted in a clockwise direction about the third direction as an axis.

17. The coil component of claim 14, wherein
the anchor portion includes a first end and a second end spaced apart from each other in the second direction, and
the first end includes the first blade and the third blade.
